(19) United States
(12) Patent Application Publication
(10) Pub. No.: US 2015/0032479 A1
(43) Pub. Date: Jan. 29, 2015

(54) Determining and Evaluating Building Codes

(71) Applicant: International Business Machines Corporation, Armonk, NY (US)

(72) Inventors: Francesco C. Schembari, Durham, NC (US); Wayne C. Sholtes, Raleigh, NC (US)

(73) Assignee: International Business Machines Corporation, Armonk, NY (US)

(21) Appl. No.: 13/951,416

(22) Filed: Jul. 25, 2013

(51) Int. Cl. G06Q 50/08; G06Q 30/00

(52) U.S. Cl. CPC G06Q 50/08; G06Q 40/08; G06Q 30/018
USPC 705/4; 705/317

(57) ABSTRACT

An approach is provided improving building codes. In the approach, building code related data retrieved from a number of sources is evaluated. The sources correspond to a first geographic location, such as a municipality, being analyzed and one or more second geographic locations (e.g., other municipalities, etc.) being used for comparison. Based on the evaluation, a negative outcome, such as a higher insurance cost, is then identified that relates to the first geographic location. The approach then identifies a building code change that could be made to the building codes of the first geographic location to address the negative outcome. The identified building code change is then recommended to be made to the set of building codes that applies to the first geographic location.

### BACKGROUND OF THE INVENTION

Building codes are a set of rules that specify the minimum acceptable level of safety for constructed objects such as buildings and other structures. The main purpose of building codes are to protect public health, safety and general welfare as they relate to the construction and occupancy of buildings and structures. The building code becomes law of a particular jurisdiction, such as a municipality, when the codes are formally enacted by the appropriate governmental or private authority. Building codes are used by a variety of people including architects and engineers that design structures, constructors that build the structures, and regulators, such as building inspectors, that inspect and ensure that the structure complies with the applicable building codes. Enacted codes are generally based on the major model building codes. For example, in the United States, model codes are developed by the International Code Council (ICC), which have 14 sets of International codes (“i-codes”), including the International Building Code (IBC), the International Residential Code, the International Fire Code, the International Energy Conservation Code, the International Plumbing Code, the International Mechanical Code and other sets of codes. A building department in a particular jurisdiction generally reviews plans that have been submitted before construction. The building department then issues, or denies, building permits. Building inspectors then verify compliance to the codes at the building site during construction.

While building codes are a critical and essential part of most any municipality, they are often defined haphazardly with little or no education provided to field inspectors, contractors, architects/engineers, and homeowners. The results of haphazardly created building codes include dangerous living conditions, rising insurance costs, and frustrated homeowners.

### SUMMARY

An approach is provided improving building codes. In the approach, building code related data retrieved from a number of sources is evaluated. The sources correspond to a first geographic location, such as a municipality, being analyzed and one or more second geographic locations (e.g., other municipalities, etc.) being used for comparison. Based on the evaluation, a negative outcome, such as a higher insurance cost, is then identified that relates to the first geographic location. The approach then identifies a building code change that could be made to the building codes of the first geographic location to address the negative outcome. The identified building code change is then recommended to be made to the set of building codes that applies to the first geographic location.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various entities and systems involved in maintaining building codes;

FIG. 4 is a depiction of a high level flowchart showing the logic used by a building code analysis engine;

FIG. 5 is a depiction of a flowchart showing the logic used in the insurance analysis performed by the building code analysis engine;

FIG. 6 is a depiction of a flowchart showing the logic used in the municipality building code analysis performed by the building code analysis engine; and

FIG. 7 is a depiction of a flowchart showing the logic used in the material analysis performed by the building code analysis engine.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

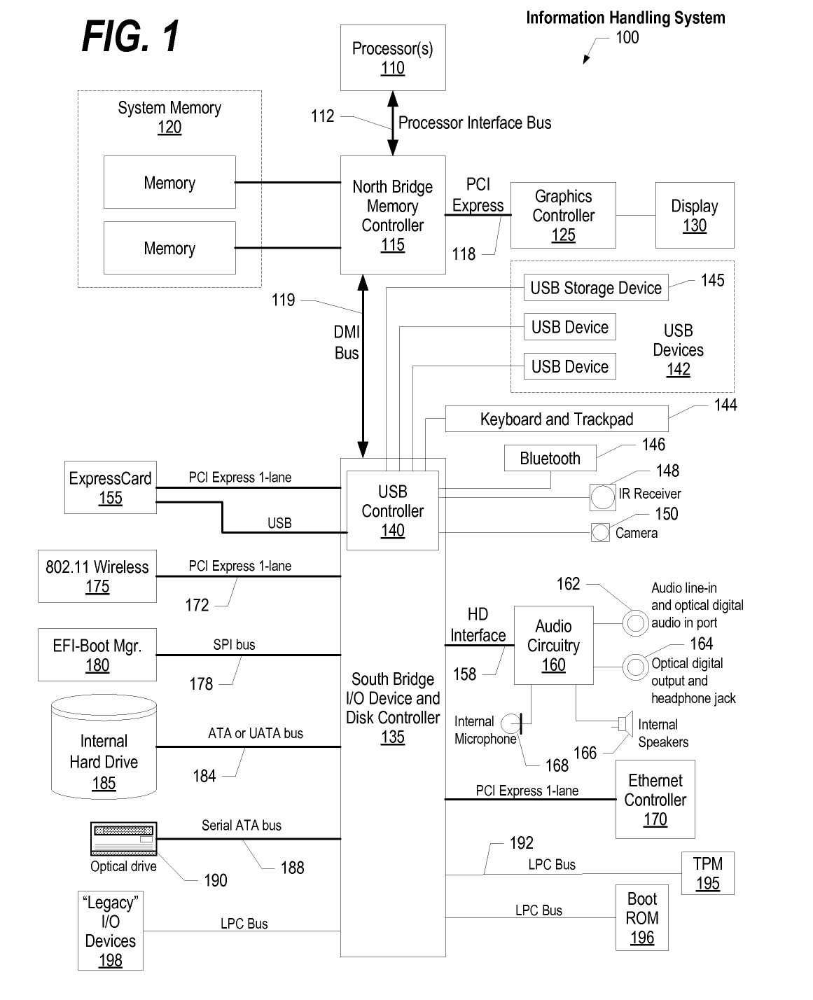

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

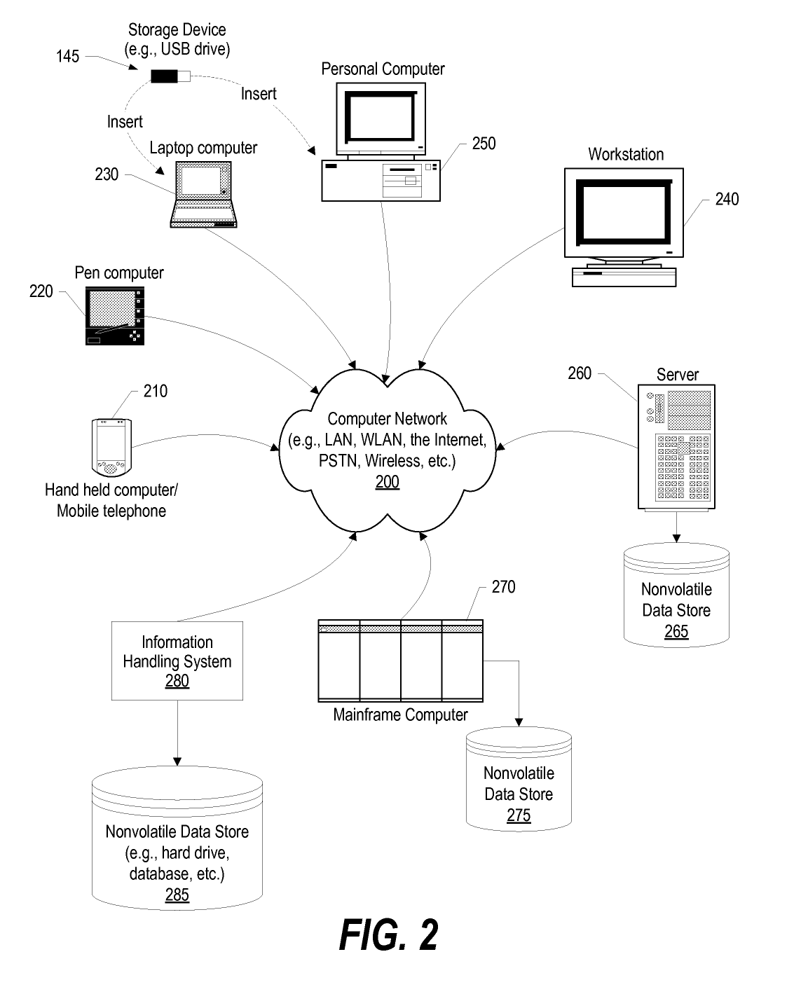

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

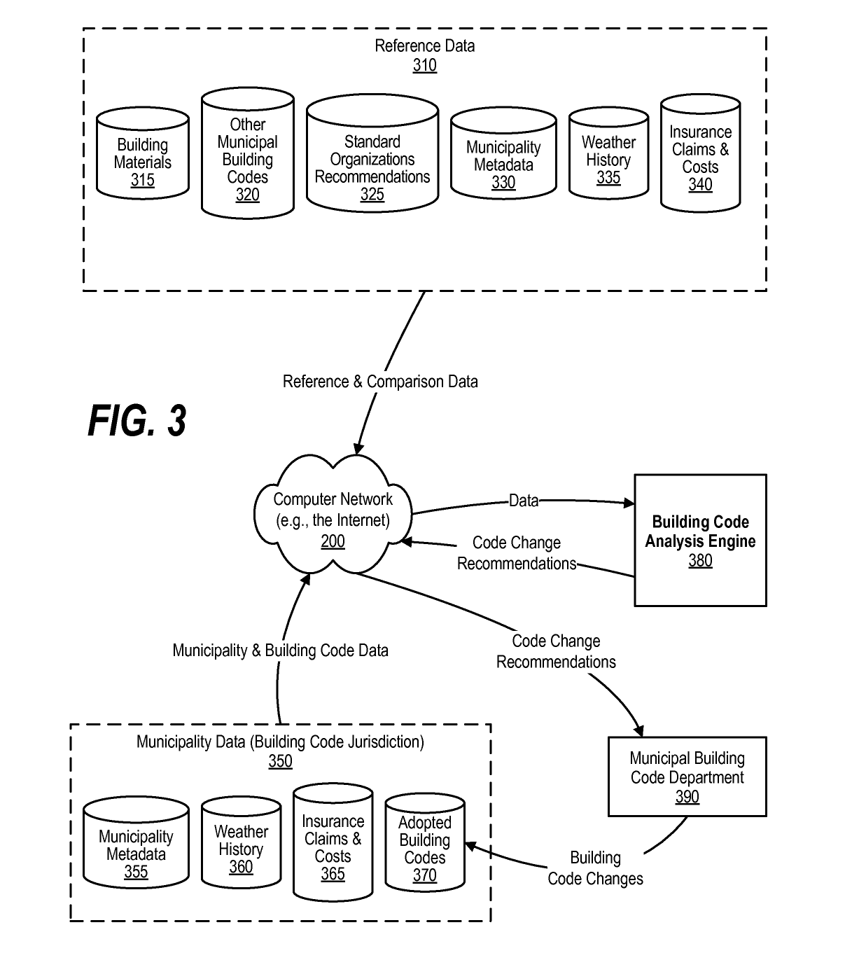

FIGS. 3-7 depict an approach that can be executed on an information handling system and computer network as shown in FIGS. 1-2. A system and method that recommends municipality building codes through the aggregation of data from a variety of resources. The system, which receives data from municipalities and suppliers, identifies building codes based on a geographic location (e.g., longitude/latitude, etc.), weather history, insurance claims, availability of supplies, and economic conditions. The identified, and recommended, building codes being those codes that are calculated to be effective building codes for the municipality. For example, the system could compare two cities with similar characteristics as mentioned above, including a history of damaging weather such as tornados or hurricanes, and identify that one city had a much higher payout of insurance policies and subsequently higher insurance costs for its citizens. The system could then determine from the building codes that the city with lower insurance costs had more stringent requirements on the building technique required to attach roofs to structures. Such analysis could result in a recommendation to the city with the higher insurance costs to adopt the roof attachment technique shown to reduce damage and thereby lower insurance costs. Furthermore, the system could recommend certain materials from supplier data with such materials being shown to lower insurance costs by reducing damage caused to structures. In this manner, the approach described herein associates common attributes of a municipality with supplier and insurance data to determine the most effective building code standards for the municipality. The approach discussed above is further described in FIGS. 3-7 and accompanying detailed descriptions, discussed below. These figures and related descriptions provide further details related to one or more embodiments that utilize various data sources to analyze and update building codes used by a particular jurisdiction or municipality.

FIG. 3 is a component diagram showing the various entities and systems involved in maintaining building codes. Building Code Analysis Engine 380 analyzes various data sources in order to recommend building code changes to municipal building code department 390, such as the building department in a city, town, county, or other jurisdiction. The various data sources can be divided into two large categories. First, reference data 310 refers to data sources available from other entities, such as other municipalities, standards organizations, building supplier data, insurance data, and other reference data. Second, municipality data 350 refers to data pertaining to the municipality whose building codes are being analyzed.

Reference data 310 includes various data sources that may be accessed locally or through computer network 200, such as the Internet. These data sources include building materials data store(s) 315 which are sources of information about various types of building materials including specifications, material data sheets, pricing data, and the like. For example, with regards to roofing materials, data regarding various types of asphalt shingles would be available as well as alternative roofing materials such as metal roofing materials. If a particular municipality required asphalt shingles but was prone to hail storms, the building code analysis engine could perform an analysis and determine that certain types of metal roofs or other alternative roofing materials might be less prone to hail damage and a good alternative, or substitute, for asphalt shingles in the municipality's building code.

Other municipal building codes 320 includes data regarding other municipalities building codes. Using the above roofing example, the analysis engine may further determine that a comparable municipality in terms of climate and susceptibility to hail storms allows metal roofing in the building code.

Standard organizations recommendations 325 includes data promulgated by various standard organizations regarding building practices. Again, using the above roofing example, a standards organization may conduct tests or experiments related to roof damage that occurs during various types of weather events, such as hail storms, high wind conditions, and the like. These organizations may also test new alternative materials in order to make appropriate recommendations. For example, the standards organization may determine that use of screws or other threaded or shanked fasteners to affix roof decking and trusses or rafters greatly reduces damage from high winds when compared to nails. In response, the standards organization may recommend use of ring shank nails or screws when affixing roof decking and supports (trusses, rafters, etc.) instead of use of common nails. Likewise, if a new composite material is developed as a roofing alternative, these standards organizations might test such composite material and recommend use of such material in certain environments. For example, some composite materials may be good at withstanding hail damage, but are found to become brittle and prone to breakage when exposed to extremely low temperatures. With such a finding, the composite material might be recommended for use in southern municipalities where frequent hail storms occur, such as Dallas, Tex., but not recommended for use in colder climates, such as Minneapolis, Minn., even though hail storms might occur in such colder climates during summer months.

Municipality metadata 330 includes latitude/longitude information of the municipality along with elevations, economic data, and proximity to areas that might possible have an effect on building or structures. These areas might include oceans where hurricanes could develop, fault lines where earthquakes are more likely to occur, heavy forest areas where fire danger may be increased, water table data and geology data that might increase the danger of mudslides, sinkholes, and the like.

Weather history data 335 is weather data corresponding to the other municipalities so that the building code analysis engine can better analyze a particular municipality with respect to other municipalities that experience similar weather. This weather history data would include monthly average temperature and humidity ranges, monthly precipitation ranges, sunlight averages, and any other weather data that might be useful when selecting building codes.

Insurance claims and cost data 340 includes insurance costs related to the other municipalities so that the building code analysis engine can better analyze a particular municipality with respect to other municipalities in terms of insurance claims and costs incurred. For example, using the roofing example from above, the analysis engine might identify two municipalities similar in terms of geographic location, climate, and the like, however one of the municipalities has higher insurance claims and costs regarding when high wind events occur. The analysis engine could then determine that the municipality with the lower insurance claims and costs has a building code that requires more robust fasteners to affix roof decking materials to trusses and rafters and further requires more robust fasteners to affix the trusses/rafters to the exterior wall roof plates. While slightly more expensive to construct, the additional expense may be shown to be more than outweighed by the lower insurance costs likely to be incurred by homeowners. In such a situation the building code analysis engine could recommend that the more robust fastening techniques be adopted by the municipality with the higher insurance rates.

Municipality data 350 includes data regarding the municipality whose building codes are being analyzed by Building Code Analysis Engine 380. These data stores align with reference data stores and are used for analysis and comparisons performed by the analysis engine. Municipality metadata 355 includes the same types of data as found in municipality metadata 330 so that similar municipalities can be identified in terms of latitude/longitude information of the municipality along with elevations, economic data, and proximity to areas that might possible have an effect on building or structures. Weather history data 360 is weather data corresponding to the municipality that is being analyzed. Weather history data 360 includes the same types of data as found in weather history data 335 so that similar municipalities can be identified in terms of likely weather patterns and events. Insurance claims and cost data 365 is insurance claims and cost data pertaining to the municipality that is being analyzed. This insurance claims and cost data is the same type of data that is found in insurance claims and cost data 340 so that differences and similarities can be identified between the municipality being analyzed and other similar municipalities. Adopted building code data 370 are those building codes that have been adopted by the municipality that is being analyzed. This building code data includes the same type of information as found in other municipalities building codes 320 so that adopted building codes can be compared and distinguished with regard to building codes that are in use by other municipalities.

Building Code Analysis Engine 380 receives data from both references sources 310 as well as municipality sources 350 (the municipality that is being analyzed). This data includes building materials data, building code data, standards organizations data, municipality metadata, weather history data, and insurance claims/cost data. Building Code Analysis Engine 380 processes the received data and generates building code recommendations that are transmitted to Municipal Building Code Department 390 for further evaluation and processing according to the municipalities procedures in order to be enacted and used to update the municipality's adopted building codes (data store 370).

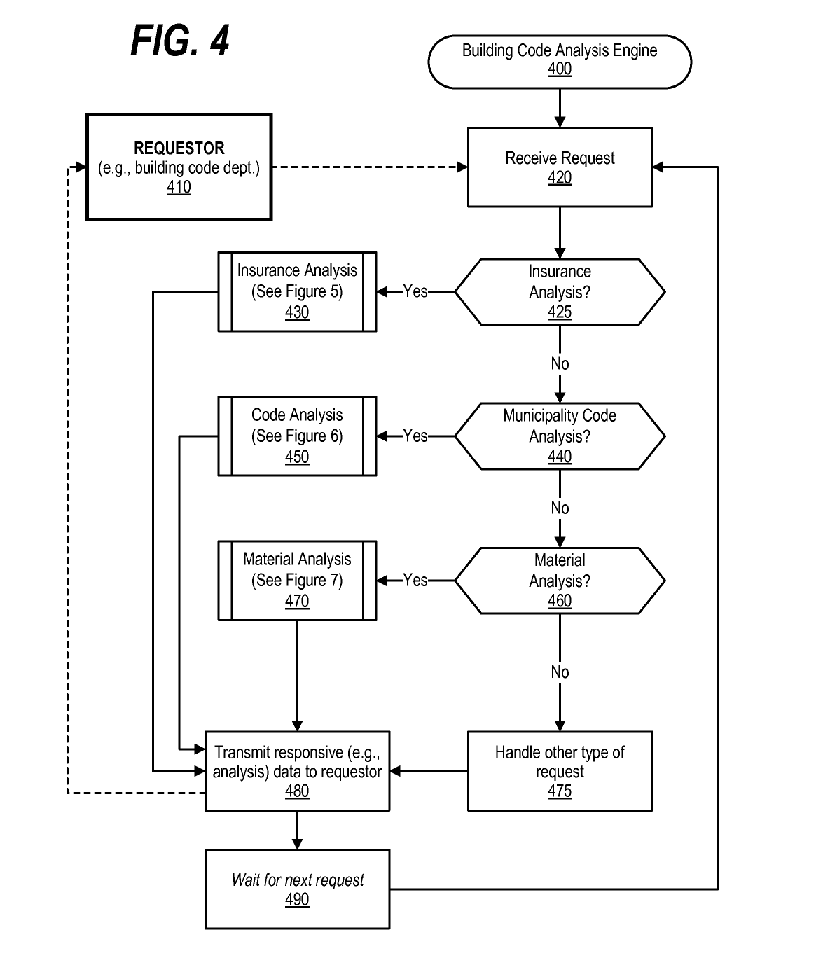

FIG. 4 is a depiction of a high level flowchart showing the logic used by a building code analysis engine. Processing performed by the Building Code Analysis Engine commences at 400 whereupon, at step 420, the process receives a request from requestor 410. The requestor may be another process being executed by the building code department or may be a request by an individual, such as an administrator, that works for the municipality and is responsible for reviewing or updating the municipality's building codes.

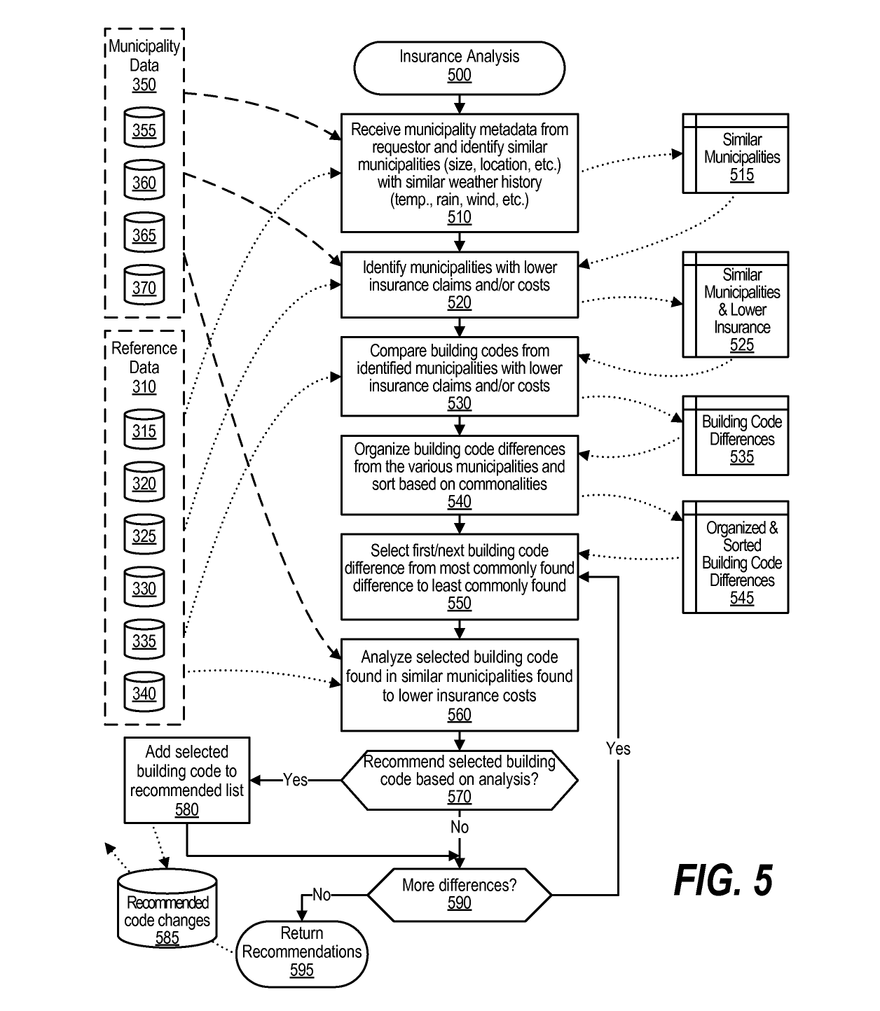

A decision is made as to whether the request is to perform a property insurance analysis for the municipality (decision 425). If the request is to perform a property insurance analysis, then decision 425 branches to the “yes” branch whereupon, at predefined process 430, the process performs the property insurance analysis (see FIG. 5 and corresponding text for processing details). On the other hand, if the request is not to perform a property insurance analysis for the municipality, then decision 425 branches to the “no” branch for further processing.

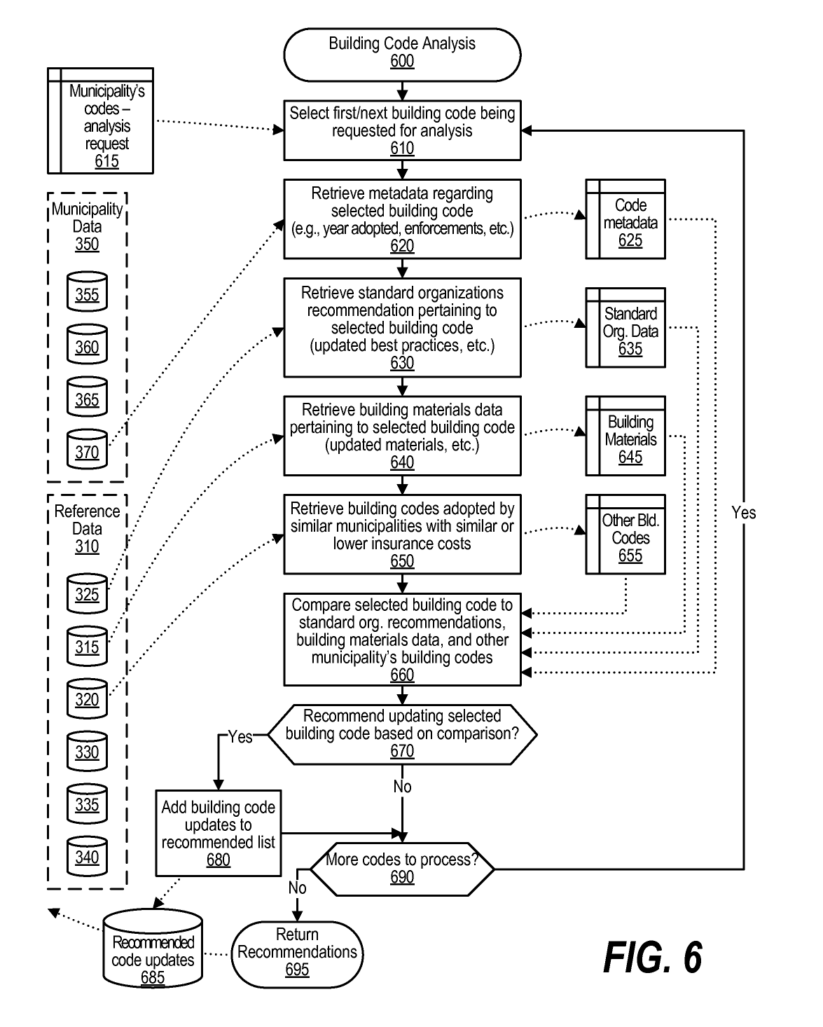

A decision is made as to whether the request is to perform a building code analysis of the municipality's building codes (decision 440). If the request is to perform a building code analysis of the municipality's building codes, then decision 440 branches to the “yes” branch whereupon, at predefined process 450, the process performs building code analysis of the municipality's building codes (see FIG. 6 and corresponding text for processing details). On the other hand, if the request is not to perform a building code analysis of the municipality's building codes, then decision 440 branches to the “no” branch for further processing.

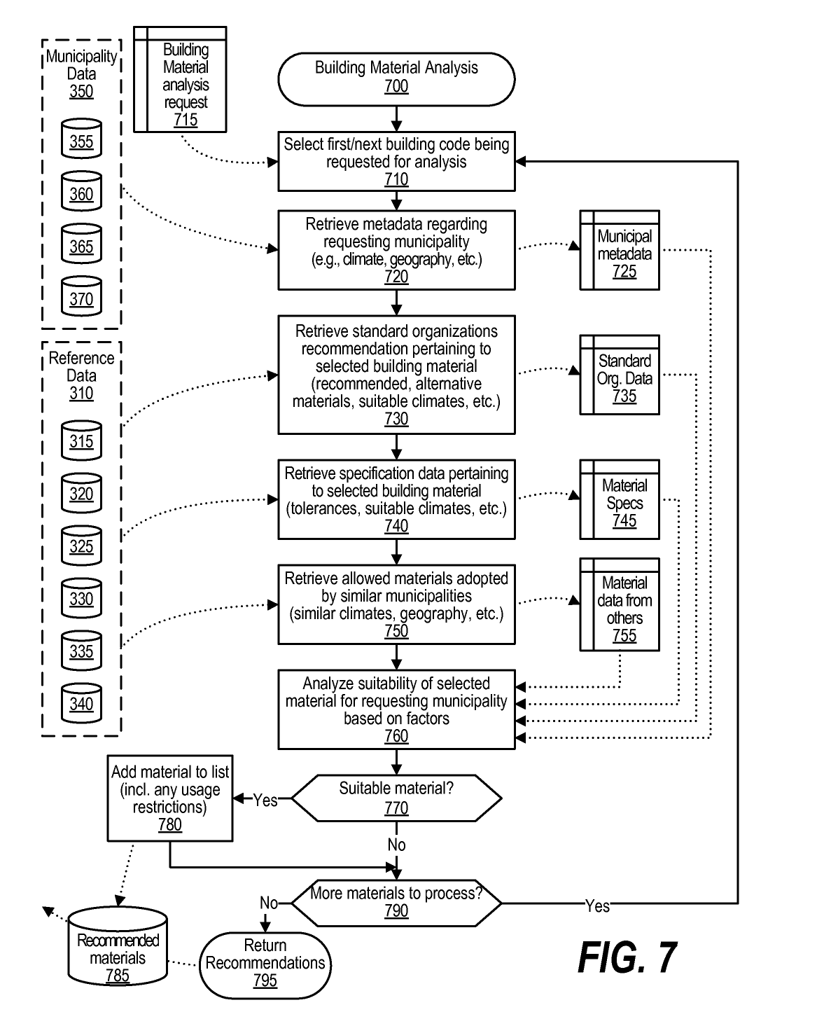

A decision is made as to whether the request is to perform a building material analysis of one or more building materials to include or remove from the building materials allowed by the municipality's building codes (decision 460). If the request is to perform a building material analysis, then decision 460 branches to the “yes” branch whereupon, at predefined process 470, the process performs building material analysis (see FIG. 7 and corresponding text for processing details). On the other hand, if the request is not to perform a building material analysis, then decision 460 branches to the “no” branch whereupon, at step 475, the processing handles the request (e.g., configure data stores, etc.).

At step 480, the analysis performed by the Building Code Analysis Engine is transmitted back to requestor 410. The analysis may include a recommended building code change identified by the Building Code Analysis Engine that is used to change the building codes that apply to the municipality (a geographic location such as a city, town, county, etc.). Building Code Analysis Engine processing then waits for the next request to be received from a requestor. When the next request is received, processing loops back to step 420 to receive and process the next request as described above.

FIG. 5 is a depiction of a flowchart showing the logic used in the insurance analysis performed by the building code analysis engine. Insurance analysis processing commences at 500 whereupon, at step 510, the process receives municipality metadata from data stores 350 and identifies similar municipalities (e.g., in terms of size, geographic location, etc.) that also have similar weather histories (e.g., average monthly temperatures, average monthly rainfall and precipitation totals, severe storm types and amounts, etc.). Data regarding the identified similar municipalities is stored in memory area 515.

At step 520, the process retrieves insurance cost and claims data pertaining to the municipalities with data stored in memory area 515. Data regarding those similar municipalities found to have lower insurance costs (e.g., insurance claims costs, insurance premium costs, etc.) are stored in memory area 525.

At step 530, the process compares the building codes pertaining to the similar municipalities that have lower insurance costs (stored in memory area 525) with the building codes that have been adopted by the municipality that is being analyzed. Building code differences found between the municipality being analyzed and the similar municipalities is stored in memory area 535. For example, municipalities with lower insurance costs may have building codes requiring more robust roofing fasteners. At step 540, the building code differences that have been identified and stored in memory area 535 are organized based on commonalities and the organized and sorted data is stored in memory area 545. For example, if ten similar municipalities are found with lower insurance costs and every one of the municipalities requires the more robust roofing fasteners, then this commonality (more robust roofing fasteners) would be grouped with an indication that this building code difference is common among the similar municipalities. On the other hand, a building code difference only noted with one municipality would still be stored in memory area 545, however it would be noted based on the order in which the building code difference appears in memory area 545 that such difference was not widespread among the other municipalities. In this manner, those building code differences common to municipalities with lower insurance costs are brought to the forefront and noted as being a likely difference that could result in lower insurance costs.

At step 550, the process selects the first building code difference from memory area 545 with memory area 545 being sorted in order from the most common building code difference noted in the other municipalities to the least common building code difference. At step 560, the selected building code difference is analyzed based on material cost data and other reference data found in data stores 310. The analysis takes into account the number of similar municipalities that have adopted the building code difference. In one embodiment, the analysis performed at step 560 also includes a cost-benefit analysis that estimates the estimated insurance cost savings of adopting the identified building code change with the estimated cost of construction (e.g., materials cost, labor cost, etc.) of building structures after adoption of the building code change. For example, with regard to more robust roofing fasteners, the estimated insurance savings may be $50 per year with the estimated increase in building cost for an average home being $200. In this example, the cost-benefit analysis would show that the increase building cost would be covered by savings in insurance costs in approximately four years. In addition, in the event of a severe wind event, the damage estimate to a home constructed with the more robust fasteners may be estimated at an average of $1,000 for shingle and other damage, while the damage estimate to a home built with less robust fasteners, such as common nails, may be catastrophic and estimated in excess of $25,000 due to the damage caused by the excessive winds more easily tearing off the roof decking and separating the roof trusses/rafters from the exterior wall roof plates. In a further embodiment, the process calculates a score related to the similar municipalities. For example, an identical (theoretical) municipality would receive a score of 1.0 with other municipalities receiving smaller scores based upon their differences with the municipality that is being evaluated. For example, very similar municipalities might receive a score from 0.90 to 0.99, similar municipalities might receive a score from 0.80 to 0.99 and somewhat similar municipalities might receive a score from 0.70 to 0.79. These scores can then be used as weighting factors during both the selection of similar municipalities (e.g., municipalities with scores lower than 0.70 do not meet the criteria for being a similar municipality, etc.) as well as in the analysis of building codes and costs where such differences may be a factor in either, or both, a difference in building codes and a difference in insurance costs. The similarity score can be then used as a weighting value to apply against insurance costs and perspective building code changes.

A decision is made, based on the analysis, as to whether to add the selected building code change to the list of recommended changes that should be made to the municipality's building codes (decision 570). If, based on the analysis, the selected building code change should be added to the list of recommended changes that should be made to the municipality's building codes, then decision 570 branches to the “yes” branch whereupon, at step 580, the selected building code change is added to recommendation list 585. On the other hand, if the selected building code change should not be added to the list of recommended changes that should be made to the municipality's building codes, then decision 570 branches to the “no” branch bypassing step 580.

A decision is made as to whether there are more building code differences stored in memory area 545 that need to be processed (decision 590). If there are more differences to process, then decision 590 branches to the “yes” branch which loops back to select and analyze the next building code difference as described above. This looping continues until all of the building code differences have been analyzed, at which point decision 590 branches to the “no” branch whereupon processing returns to the calling routine (see FIG. 4) at 595. The recommended building code changes stored in data store 585 are returned to the calling routine and returned to the requestor (e.g., the municipality's building department, etc.).

FIG. 6 is a depiction of a flowchart showing the logic used in the municipality building code analysis performed by the building code analysis engine. Building code analysis processing commences at 600 whereupon, at step 610, the process selects the first building code that is being requested for analysis. Building code analysis request 615 includes any number of the municipality's building codes that are being analyzed. In addition, the entire set of the municipality's building codes may be periodically analyzed in order to identify outdated building codes or building codes that ought to be updated based upon new or improved building materials and techniques.

At step 620, the process retrieves metadata regarding the selected building code from data store 370 which is one of municipality's data stores 350. The building code metadata includes any data pertaining to the building code such as the year the building code was adopted by the municipality, the enforcement history of the building code (e.g., number of violations found, etc.), and any other data pertaining to the building code. The retrieved building code metadata is stored in memory area 625.

At step 630, the process retrieves data from standards organizations data store(s) 325 which is one of reference data stores 310 and may be accessible through a computer network, such as the Internet. The retrieved standards organization data pertains to the selected building code and may include such information as recommended best practices (building techniques, etc.), recommended materials, and improvements found to previously used techniques or materials. The retrieved standards organization data is stored in memory area 635.

At step 640, the process retrieves building material data from building materials data store 315 which is one of reference data stores 310 and may be accessible through a computer network, such as the Internet. The retrieved building materials data pertains to the selected building code and may include such information as manufacturer specifications and tolerances for the building materials used to comply with the selected building code and improved or substitute materials that may have become available since the building code was first adopted. The retrieved building material data is stored in memory area 645.

At step 650, the process retrieves building codes that have been adopted by similar municipalities. In one embodiment, such using the process shown in steps 510-520 in FIG. 5, the process may identify similar municipalities that have lower insurance costs than the municipality that is being analyzed. The building codes that are retrieved correspond to the municipality's building code that was selected at step 610. For example, if the selected building code pertains to roofing practices and building materials, the corresponding building codes retrieved from similar municipalities would also pertain to roofing practices and building materials. Building codes that apply to other similar municipalities are stored in memory area 655.

At step 660, the Building Code Analysis Engine compares the municipality's selected building code to recommendations promulgated by standards organizations, compares the selected building code to retrieved building materials data, and compares the selected building code to related building codes that have been adopted by similar municipalities. The comparison may find a better building practice or building material that could be used to update the municipality's selected building code. A decision is made as to whether, based on the comparison, the process should recommend a change to the municipality's selected building code (decision 670). If such a change is recommended, then decision 670 branches to the “yes” branch whereupon, at step 680, the selected building code change is added to recommendation list 685. On the other hand, if such a change is not recommended, then decision 670 branches to the “no” branch bypassing step 680.

A decision is made as to whether there are more building codes in request 615 that need to be processed (decision 690). If there are building codes to process, then decision 690 branches to the “yes” branch which loops back to select and analyze the next building code from request 615. This looping continues until all of the building codes in request 615 have been analyzed, at which point decision 690 branches to the “no” branch whereupon processing returns to the calling routine (see FIG. 4) at 695. The recommended building code changes stored in data store 685 are returned to the calling routine and returned to the requestor (e.g., the municipality's building department, etc.).

FIG. 7 is a depiction of a flowchart showing the logic used in the material analysis performed by the building code analysis engine. Building material analysis request processing commences at 700 whereupon, at step 710, the process selects the first building code being requested for analysis from building material analysis request 715. Such a request may be made for a variance or building code change is being evaluated when a building material shortage exists or when an improved or substitute building material is developed and marketed by a building material manufacturer. At step 720, the process retrieves metadata regarding the municipality for which the building material is being requested. The metadata would include such data as climate data, geography data, geology data, etc. The retrieved municipality metadata is stored in memory area 725.

At step 730, the process retrieves data from standards organizations data store(s) 325 which is one of reference data stores 310 and may be accessible through a computer network, such as the Internet. The retrieved standards organization data pertains to the selected building material and may include such information as whether the selected building material is a recommended material, alternative building materials available instead of the selected building material, suitable climates in which the selected building material should be used, as well as any other data pertaining to the selected building material. The retrieved standards organization data is stored in memory area 735.

At step 740, the process retrieves building material specification data pertaining to the selected building material. Such building material specification data may include material tolerances, suitable climates for the material, etc. The retrieved material specification data is stored in memory area 745.

At step 750, the process retrieves building codes that have been adopted by similar municipalities. In one embodiment, such using the process shown in steps 510-520 in FIG. 5, the process may identify similar municipalities that have lower insurance costs than the municipality that is being analyzed. The building codes that are retrieved correspond to the building material that was selected at step 710. For example, if the selected building code pertains to asphalt shingles used in roofing, the corresponding building codes retrieved from similar municipalities would pertain to roofing building codes. Building codes that apply to other similar municipalities are stored in memory area 755.

At step 760, the Building Code Analysis Engine compares the municipality's metadata (memory area 725) to recommended building materials promulgated by standards organizations (memory area 735), compares the building materials specification data (memory area 745) to municipal metadata (such as climate conditions), and also compares the selected building material to building materials that have been adopted (allowed) by similar municipalities (memory area 755). The Building Code Analysis Engine determines, based on the aforementioned comparisons, whether the requested building material is a suitable building material for use in the municipality with respect to one or more of the municipality's building codes (decision 770). If the building material is a suitable material for one or more applications, then decision 770 branches to the “yes” branch whereupon, at step 780, the selected building material is added to recommended material list 785. In addition, any particular usage restrictions related to the building material are also written to list 785. For example, a composite board may be deemed a suitable alternative for decking applications but lacks structural integrity and is not suitable for use as a structural member, such as use in a header or wall stud. Returning to decision 770, if the material is not a suitable building material, then decision 770 branches to the “no” branch bypassing step 780.

A decision is made as to whether there are more building materials in request 715 that need to be processed (decision 790). If there are building materials to process, then decision 790 branches to the “yes” branch which loops back to select and analyze the next building material from request 715. This looping continues until all of the building materials in request 715 have been analyzed, at which point decision 790 branches to the “no” branch whereupon processing returns to the calling routine (see FIG. 4) at 795. The recommended building materials stored in data store 785 are returned to the calling routine and returned to the requestor (e.g., the municipality's building department, etc.).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method, performed by an information handling system comprising a processor and a memory, of improving building codes, the method comprising:
computing, using the processor, a similarity score pertaining to each of a plurality of geographic locations, wherein each of the similarity scores is based on a comparison of the geographic locations with a first geographic location, wherein one or more second geographic locations are selected based on the similarity scores, and wherein the similarity scores are stored in the memory;
evaluating building code related data retrieved from a plurality of sources, wherein the plurality of sources correspond to the first geographic location and the one or more second geographic locations;
calculating a negative outcome related to the first geographic location based on the evaluation;
identifying a building code change, wherein the building code change is related to the negative outcome; and
recommending that the identified building code change be made to a first set of building codes that applies to the first geographic location.

2. The method of claim 1 wherein the calculated negative outcome is a higher insurance cost pertaining to the first geographic location, the method further comprising:
selecting the selected second geographic locations that have lower insurance costs than the first geographic location;
comparing one or more sets of building codes pertaining to the selected second geographic locations to the first set of building codes, the comparison resulting in one or more building code differences; and
analyzing the resulting building code differences with regard to the higher insurance cost, the analysis resulting in the identified building code change.

3. The method of claim 2 wherein the similarities between the first geographic location and the selected second geographic locations include similar weather histories, and wherein the method further comprises:
identifying one or more building code differences that are more commonly found in the sets of building codes that pertain to the selected second geographic locations.

4. The method of claim 1 wherein the negative outcome is an outdated building material requirement, and wherein the method further comprises:
retrieving metadata pertaining to a building material related to the building material requirement;
identifying one or more substitute building materials relating to the building material requirement; and
analyzing the identified substitute building materials, wherein the analysis results in at least one of the identified substitute building materials being included in the identified building code change.

5. The method of claim 4 wherein the analysis further comprises:
retrieving material metadata corresponding to each of the identified substitute building materials, wherein one of the material metadata is a recommended material climate data; and
comparing the recommended material climate data with a climate data pertaining to the first geographic location.

6. The method of claim 5 wherein the analysis further comprises:
searching one or more sets of building codes pertaining to the second geographic locations, wherein the second geographic locations are similar to the first geographic location, and wherein the search results in a list of building code sets that allow the identified substitute building materials.

7. The method of claim 6 wherein the analysis further comprises:
retrieving a first insurance cost associated with the first geographic location;
retrieving a set of second insurance costs associated with the second geographic locations having sets of building codes that allow the identified substitute building materials; and
comparing the first insurance cost with the set of second insurance costs.

8. An information handling system comprising:
one or more processors;
a memory coupled to at least one of the processors;
a network adapter that connects the information handling system to a computer network; and
a set of instructions stored in the memory and executed by at least one of the processors, wherein the set of instructions perform steps of:
computing a similarity score pertaining to each of a plurality of geographic locations, wherein each of the similarity scores is based on a comparison of the geographic locations with a first geographic location, wherein one or more second geographic locations are selected based on the similarity scores, and wherein the similarity scores are stored in the memory;
evaluating building code related data retrieved from a plurality of sources, wherein the plurality of sources correspond to the first geographic location and the one or more second geographic locations;
calculating a negative outcome related to the first geographic location based on the evaluation;
identifying a building code change, wherein the building code change is related to the negative outcome; and
recommending that the identified building code change be made to a first set of building codes that applies to the first geographic location.

9. The information handling system of claim 8 wherein the calculated negative outcome is a higher insurance cost pertaining to the first geographic location, and wherein the steps further comprise:
selecting the selected second geographic locations that have lower insurance costs than the first geographic location;
comparing one or more sets of building codes pertaining to the selected second geographic locations to the first set of building codes, the comparison resulting in one or more building code differences; and
analyzing the resulting building code differences with regard to the higher insurance cost, the analysis resulting in the identified building code change.

10. The information handling system of claim 9 wherein the similarities between the first geographic location and the selected second geographic locations include similar weather histories, and wherein the steps further comprise:
identifying one or more building code differences that are more commonly found in the sets of building codes that pertain to the selected second geographic locations.

11. The information handling system of claim 8 wherein the negative outcome is an outdated building material requirement, and wherein the steps further comprise:
retrieving metadata pertaining to a building material related to the building material requirement;
identifying one or more substitute building materials relating to the building material requirement; and
analyzing the identified substitute building materials, wherein the analysis results in at least one of the identified substitute building materials being included in the identified building code change.

12. The information handling system of claim 11 wherein the analysis further comprises:
retrieving material metadata corresponding to each of the identified substitute building materials, wherein one of the material metadata is a recommended material climate data; and
comparing the recommended material climate data with a climate data pertaining to the first geographic location.

13. The information handling system of claim 12 wherein the analysis further comprises:
searching one or more sets of building codes pertaining to the second geographic locations, wherein the second geographic locations are similar to the first geographic location, and wherein the search results in a list of building code sets that allow the identified substitute building materials;
retrieving a first insurance cost associated with the first geographic location;
retrieving a set of second insurance costs associated with the second geographic locations having sets of building codes that allow the identified substitute building materials; and
comparing the first insurance cost with the set of second insurance costs.

14. A computer program product stored in a computer readable memory, comprising computer instructions that, when executed by an information handling system, causes the information handling system to perform actions comprising:
computing, using the processor, a similarity score pertaining to each of a plurality of geographic locations, wherein each of the similarity scores is based on a comparison of the geographic locations with a first geographic location, wherein one or more second geographic locations are selected based on the similarity scores, and wherein the similarity scores are stored in the memory;
evaluating building code related data retrieved from a plurality of sources, wherein the plurality of sources correspond to the first geographic location and the one or more second geographic locations;
calculating a negative outcome related to the first geographic location based on the evaluation;
identifying a building code change, wherein the building code change is related to the negative outcome; and
recommending that the identified building code change be made to a first set of building codes that applies to the first geographic location.

15. The computer program product of claim 14 wherein the calculated negative outcome is a higher insurance cost pertaining to the first geographic location, the actions further comprising:
selecting the selected second geographic locations that have lower insurance costs than the first geographic location;
comparing one or more sets of building codes pertaining to the selected second geographic locations to the first set of building codes, the comparison resulting in one or more building code differences; and
analyzing the resulting building code differences with regard to the higher insurance cost, the analysis resulting in the identified building code change.

16. The computer program product of claim 15 wherein the similarities between the first geographic location and the selected second geographic locations include similar weather histories, and wherein the actions further comprise:
identifying one or more building code differences that are more commonly found in the sets of building codes that pertain to the selected second geographic locations.

17. The computer program product of claim 14 wherein the negative outcome is an outdated building material requirement, and wherein the actions further comprise:
retrieving metadata pertaining to a building material related to the building material requirement;
identifying one or more substitute building materials relating to the building material requirement; and
analyzing the identified substitute building materials, wherein the analysis results in at least one of the identified substitute building materials being included in the identified building code change.

18. The computer program product of claim 17 wherein the analysis further comprises actions of:
retrieving material metadata corresponding to each of the identified substitute building materials, wherein one of the material metadata is a recommended material climate data; and
comparing the recommended material climate data with a climate data pertaining to the first geographic location.

19. The computer program product of claim 18 wherein the analysis further comprises actions of:
searching one or more sets of building codes pertaining to the second geographic locations, wherein the second geographic locations are similar to the first geographic location, and wherein the search results in a list of building code sets that allow the identified substitute building materials.

20. The computer program product of claim 19 wherein the analysis further comprises actions of:
retrieving a first insurance cost associated with the first geographic location;
retrieving a set of second insurance costs associated with the second geographic locations having sets of building codes that allow the identified substitute building materials; and
comparing the first insurance cost with the set of second insurance costs.
